(19) United States
(12) Patent Application Publication
(10) Pub. No.: US 2017/0285895 A1
(43) Pub. Date: Oct. 5, 2017

(54) COMMUNICATING EDITING CONTEXT BETWEEN USERS TO INITIATE COLLABORATIVE EDITING OF ELECTRONIC DOCUMENTS

(71) Applicant: Microsoft Technology Licensing, LLC, Redmond, WA (US)

(72) Inventors: Nikhil Nathwani, Cambridge, MA (US); Benjamin Wilde, Quincy, MA (US)

(21) Appl. No.: 15/087,045

(22) Filed: Mar. 31, 2016

(51) Int. Cl. G06F 3/0484; G06F 17/24

(52) U.S. Cl. CPC G06F 3/0484; G06F 17/24

(57) ABSTRACT

To improve the ease with which end users can initiate collaborative editing sessions on an electronic document, an end user application is configured to allow a first end user to send a message through a communication application to a second user, where that message automatically incorporates the context from the end user application used by the first end user. After receiving this message, the second end user can activate the end user application using the context provided by the message. The context includes at least an identifier of the document being edited by the first end user. This context also can include a current location within the document that the first end user is viewing or editing. The second end user can activate the end user application, opening the electronic document to the current location used by the first user.

### BACKGROUND

The availability of shared storage systems for electronic documents has increased the ability of computer end users to share and to collaborate in the creation of a variety of electronic documents. End users can cause electronic documents to be stored in shared storage systems on a computer network, such as the internet. End users can instruct such a shared storage system to allow electronic documents to be shared with other end users of the shared storage system. A shared storage system generally has an access control component in a file system that tracks, for each electronic document, the access rights that different users have for the electronic document.

After an electronic document has been shared among two or more end users, the shared storage system manages access to the shared electronic document to ensure consistency of the electronic document, especially in the case of collaborative editing of, i.e., collaborative modifications to, the electronic document. A collaboration system manages collaborative modification by tracking which end users currently are using end user applications on client computers to access the same electronic document. The collaboration system typically is implemented as one or more computer programs executing on the server computer, and, in some implementations, may have components executing on the client computers.

Generally speaking, users also communicate about their work through communication channels outside of the context of an electronic document edited in an end user application. For example, users may send messages, such as chat messages, instant messages, text messages, electronic messages and the like, to each other. Such messages are sometimes about an electronic document through a communication application. Typically, users pay more frequent attention to messages provided by communications applications than to other end user applications. Users often send messages through such communication applications in order to coordinate when to have sessions when they are collaboratively editing electronic documents at the same time.

### SUMMARY

This Summary is provided to introduce a selection of concepts in a simplified form that are further described below in the Detailed Description. This Summary is intended neither to identify key or essential features, nor to limit the scope, of the claimed subject matter.

To improve the ease with which end users can initiate collaborative editing sessions on an electronic document, an end user application is configured to allow a first end user to send a message through a communication application to a second user, where that message automatically incorporates the context from the end user application used by the first end user. After receiving this message, the second end user can activate the end user application using the context provided by the message. The context includes at least an identifier of the document being edited by the first end user. This context also can include a current location within the document that the first end user is viewing or editing. The second end user can activate the end user application, opening the electronic document to the current location used by the first user.

The end user application can be configured to allow such communications to be initiated as an option in response to user input associated with any identifier of the second user as displayed within the end user application. For example, document markup, a comment, a document message, or an indicator of sharing state, and other metadata associated with an electronic document, can be associated with another end user. The end user application can display an indicator of the other end user when displaying such metadata. In response to user input associated with that other end user, a message can be initiated for sending to that end user through a communication application, where the message includes the context of the end user application.

In the following description, reference is made to the accompanying drawings which form a part hereof, and in which are shown, by way of illustration, specific example implementations. Other implementations may be made without departing from the scope of the disclosure.

### BRIEF DESCRIPTION OF THE DRAWINGS

FIG. 1 is a block diagram of an example computer system configured to support collaborative editing of electronic documents through end user applications on multiple client computers.

FIG. 2 is a diagram illustrating data structures for storing comment data, activity data and sharing state data for an electronic document.

FIG. 3 is an illustration of an example graphical user interface for an end user application for displaying comment data, activity data and sharing state data in an end user application in the context of an electronic document.

FIG. 4 is an illustration of an example graphical user interface of a communication application for displaying a message prepopulated with user and document information.

FIG. 5 is a data flow diagram of an example computer system incorporating client computers of two users.

FIG. 6 is a flow chart describing an example implementation of an operation for a first end user application.

FIG. 7 is a flow chart describing an example implementation of an operation for a first communication application.

FIG. 8 is a flow chart describing an example implementation of an operation for a second communication application.

FIG. 9 is a flow chart describing an example implementation of an operation for a second end user application.

FIG. 10 is a block diagram of an example computer.

### DETAILED DESCRIPTION

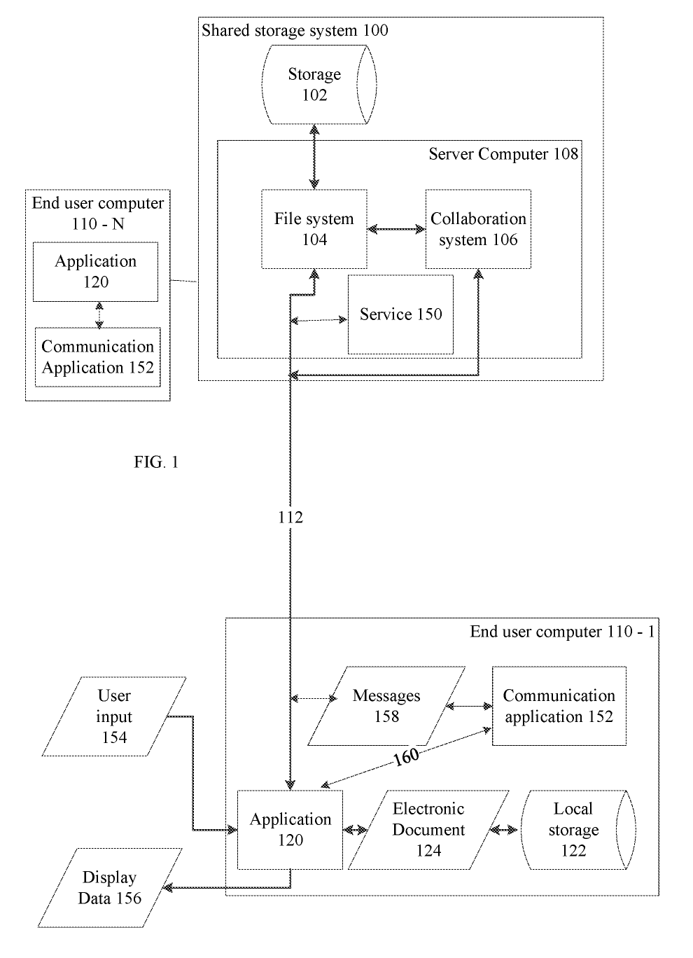

FIG. 1 is a block diagram of an example computer system configured to support collaborative editing of electronic documents by multiple end users through end user applications on multiple client computers, including communication applications.

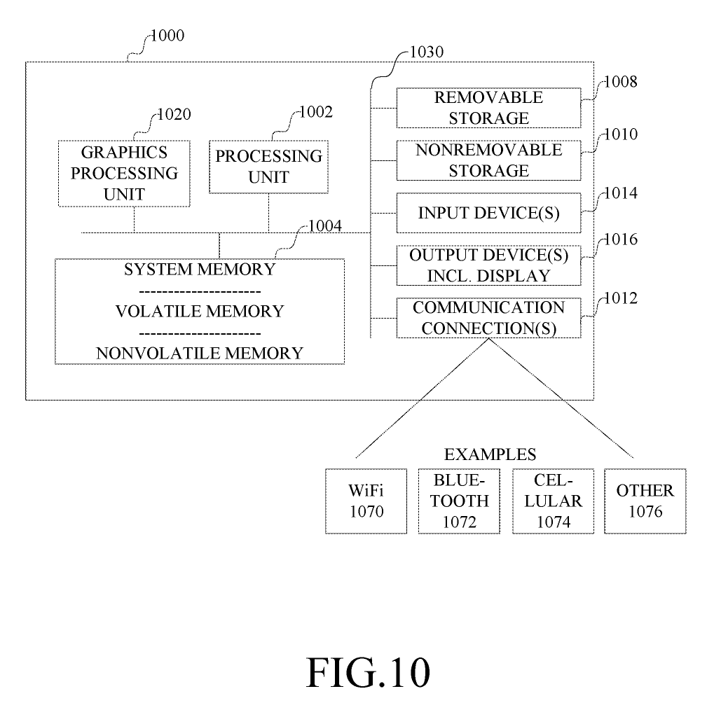

A computer system that is configured to support sharing and collaborative modification of electronic documents through multiple end user applications can include a shared storage system 100. The shared storage system 100 generally includes storage 102 in which data is stored in data files accessible through a file system 104 that is part of the shared storage system. The file system configures a server computer 108 to maintain information about each file stored in storage 102. The shared storage system 100 can be implemented using one or more general purpose computers, such as described in connection with FIG. 10, and configured to implement one or more server computers. The shared storage system 100 is responsive to requests over a computer network 112 to access, through the file system 104, files on the storage 102.

Multiple end user computers 110-1 to 110-N, also called client computers herein, are connected to the shared storage system for communication over one or more computer networks 112, such as the internet or a private computer network. An end user computer 110 can be a computer such as described in connection with FIG. 10 and configured as a client computer running one or more end user applications 120. Examples of such a computer include, but are not limited to, a tablet computer, a slate computer, a notebook computer, a desktop computer, a virtual desktop computer hosted on a server computer, a handheld computer, and a mobile phone including a computer and applications.

The computer network 112 can be any computer network supporting interaction between the end user computers and the shared storage system, such as a local area network or a wide area network, whether private and/or publicly accessible, and can include wired and/or wireless connectivity. The computer network can be implemented using any of a number of available network communication protocols, including but not limited to Ethernet and TCP/IP.

An end user computer 110 can include one or more end user applications 120. In this context, an end user application is a computer program executed on the end user computer that configures the computer to be responsive to user input 154 to allow an end user to interactively modify an electronic document 124. An electronic document can include any kind of data, such as text, still images, video, or audio and combinations of these, and generally has data defining structure of the electronic document and data defining content of the electronic document within the defined structure. The end user application processes the electronic document, in response to user input received from input devices (not shown, but see FIG. 10). For example, the application combines data to create the structure and content of the electronic document. The application also displays or otherwise presents display data 156, such as a graphical user interface including the content according to the structure of the electronic document, through output devices (not shown, but see FIG. 10) to the end user. The application also stores the electronic document in memory and/or in a data file in local storage of the end user computer and/or in the shared storage.

A variety of kinds of end user applications can be used on an end user computer. Examples of an end user application include, but are not limited to, a word processing application, a presentation application, a note taking application, a text editing application, a paint application, an image editing application, a spreadsheet application, a desktop publishing application, a drawing application, a video editing application, and an audio editing application. An end user application can permit a variety of operations on an electronic document, such as, but not limited to, viewing and commenting without content editing, viewing and content editing, or viewing only.

An end user application generates an electronic document that is stored in a data file. Such a data file can be stored in local storage 122 and/or the shared storage system 100. The electronic document, while being modified by an end user on the end user computer, also is temporarily stored in memory on the end user computer. The end user application also may temporarily store the electronic document in a cache on local storage before committing changes to the electronic document to the data file.

An end user computer 110 also can include one or more communication applications 152. A communication application is a computer program executed on the end user computer that configures the computer to be responsive to user input to allow an end user to interactively receive and read, or compose and send, electronic messages. Display data, such as a graphical user interface including electronic messages, can be presented through output devices (not shown) to the end user. An electronic message can include any kind of data, such as text, still images, video, or audio and combinations of these, and generally includes identifiers for a sender and one or more recipients of the electronic message.

A variety of kinds of communication applications can be used on an end user computer. Examples of a communication application include, but are not limited to, an electronic mail application, an instant messaging application, a chat application, a real time voice and/or video communication application, and a notification application.

The communication application 152 can access a corresponding service 150 on the server computer 108 of the shared storage system 100, to access electronic messages for a user. The service 150, given a user identifier for the user, can identify messages received for and sent by the user, which can be stored in a user account. The service may be able to send notifications to a communication application used by the user if a message is received for the user from another user. The service 150 is implemented in the form of a server computer program executed on a server computer, and can implement any kind of communication service, such as an email server, a notification service, a chat service, a real time voice and/or video communication service, an instant messaging service or other communication service. The service 150 may be running on a server computer separate from the server computer used to implement the shared storage system.

In one example configuration, the service is a chat service and the communication application is an application on a mobile phone that enables chat communication with other users. A user can configure the chat service through the communication application to notify the user in response to any requests from another user to initiate a chat session.

As described in more detail below, the communication application 152 is configured to have an application programming interface (API) through which the end user application 120 can invoke the communication application to initiate communication with other users. In the following description, for ease of presentation and without loss of generality, the communication may be described as occurring between two users, such as a message being sent by a first user to a second user, or one user to another user. It should be understood that the system can permit a user to send a message to multiple users, and thus process messages for which multiple users are recipients.

The end user application 120, in response to user input with respect to an indication of the other user, gathers information about the current context of the end user application, such as the document identifier for the currently viewed document. The context information also can include a current location within the electronic document. The context information and an identifier of the other user(s) are provided to the communication application, as indicated at 160, which instantiates a new message 158 to the other user(s) and including the context information. In response to user input, the communication application completes and sends the message 158 to the other user(s) through the service 150.

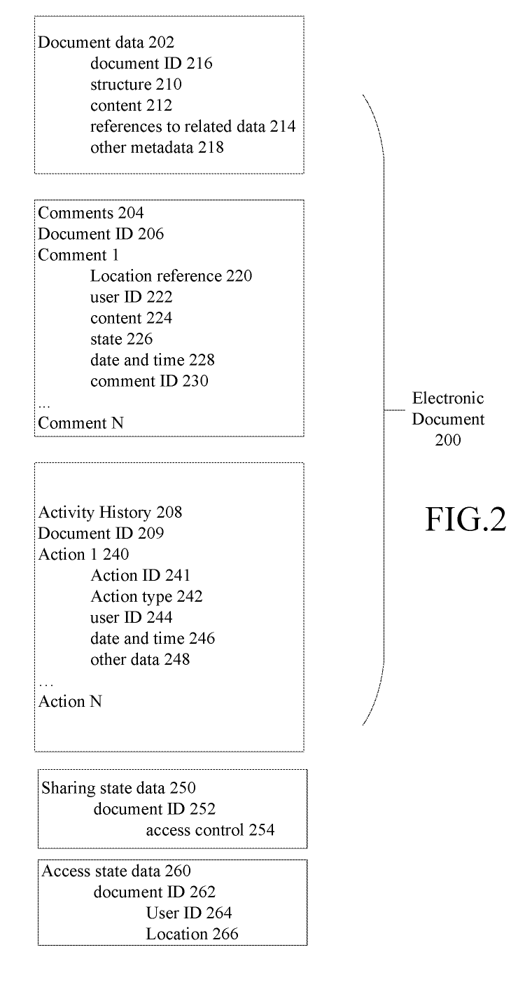

The service 150 provides the message 158 to the communication application 152 used by the other user. When the communication application 152 presents the message to the user, the communication application 152, in response to user input associated with the document identifier in the message, invokes the end user application 120 to open the electronic document corresponding to the received document identifier. The end user application 120 also can move a cursor location to the current location of the initial user (the user that sent the message) within the electronic document. More details of this process will be described below in connection with FIGS. 2-9.

For an electronic document stored in a data file in a shared storage system 100, the file system 104 of the shared storage system can include information indicating a sharing state of the electronic document. Such information can be in the form of access controls indicating which end users are authorized to access the electronic document and its related data. The file system also can be configured to be responsive to a query to provide this information to another application, such as an end user application 120 or communication application 152 on an end user computer. The shared storage system can provide information to an application on an end user computer about the sharing state of an electronic document, and permit modification to that sharing state, in a number of ways.

In some implementations, electronic documents can be shared by users by distributing a copy of the electronic document through various distribution channels among multiple users. Each user can modify the electronic document, possibly adding comments or document messages to the electronic document, and then can share the modified electronic document with additional users.

In some implementations, the electronic document is stored in a data file in the shared storage system 100, and the data file is shared, with modification rights, with at least one more end user. In such a case, two or more end user applications on two or more client computers can access and can attempt to modify the electronic document through the shared storage system 100. To handle such a condition, the shared storage system can include a collaboration system 106. The collaboration system 106 is a computer program that configures the server computer to manage contemporaneous access to shared electronic documents in the shared storage system 100. The collaboration system 106 is configured to store information about end user applications, and associated end users, that currently are accessing the electronic document. The collaboration system also can track, for each user using an electronic document, a current position within the electronic document. The collaboration system can be configured to be responsive to a query to provide this information to another application on an end user computer, such as application 120.

Using the information about end user applications and end users currently accessing an electronic document, the collaboration system can implement any of a number of different techniques for coordinating access to the electronic document to ensure consistency of the electronic document. For example, the collaboration system can prevent one end user application from causing modifications to be written to a data file for an electronic document while another the data file is open for writing by another end user application. As another example, the collaboration system can interactively merge changes to the electronic document as such changes are being made collaboratively through multiple end user applications. In such a case, as an example, the collaboration system can merge changes received from end user computers in memory local to the collaboration system, and then can transmit a modified version of the electronic document to each end user computer with an application currently accessing the document. Such modifications can include changes to the structure and/or content of the electronic document, changes to comment data associated with the electronic document, and/or updates to the activity data associated with the electronic document.

The data representing an electronic document can be stored in computer storage in a number of different formats. On the one hand, there can be a file format for one or more data files for storing data for an electronic document in persistent storage. On the other hand, there can be one or more data structures stored in memory for providing access to the data for the electronic document by an end user application during editing or viewing of the electronic document. The file format can be and typically is different from the data structure that is stored in memory, yet both store essentially the same data.

Referring now to FIG. 2, in general, and whether in a data file in persistent storage or data structure in memory, the data 200 for the electronic document includes data representing structure and content of the document 202. A variety of other data also can be stored for an electronic document. For example, such additional data can include comment data, representing structure and content of comments 204. Such additional data for an electronic document also can include activity data 208 associated with the electronic document. The activity data can include, among other things, information about actions taken with respect to the electronic document, including an indication of the user that performed the action and the action performed.

With respect to an example file format, in one implementation, the structure and content data for the document 202 and comment data 204 can be stored in one data file, and activity data 208 can be stored in a separate second data file or database. For example, activity data can be stored as a record in a database and accessible through a document identifier. In another implementation, the structure and content data for the document 202, comment data 204, and activity data 208 all can be stored in a single data file. In another implementation, the structure and content data for the electronic document 202, comment data 204, and activity data 208 each can be stored in separate data files or other data storage such as a database.

Such additional data also can include the sharing state information 250 and current access state information 260. In one implementation, the file system maintains the sharing state information 250, whereas the collaboration system maintains the current access state information 260. The sharing state information includes, as described above, for each document identifier 252, access control information 254. The current access state information includes, as described above, for each document identifier 262, the user identifier 264 for each user currently accessing the document and a location 266 indicating the user's current location in the document. Various other information can be stored as part of the sharing state data or current access state data, depending on implementation.

When such data is read by an end user application, the end user application may generate corresponding data structures in memory, which in turn are processed and stored into the data files at periodic intervals and/or in response to an instruction received from an end user.

Generally speaking, the data 202 for the electronic document includes a document identifier 216, data defining the structure 210 of the electronic document, and data defining the content 212 within that structure of the electronic document. There is a wide variety of formats for electronic documents, including various markup languages, such as the hypertext markup language (HTML), standard generalized markup language (SGML), extensible markup language (XML), as well as proprietary document formats. The invention is not limited to any particular format for the structure and content of the electronic document. The data for an electronic document may include references to other data related to the electronic document 214, such as files storing comment data, activity data, style sheets for formatting the electronic document, templates, macros and the like. The data for an electronic document also may include various metadata 218 about the electronic document.

Comment data 204 defining a collection of comments can include a document identifier 206 indicating the electronic document to which the collection of comments is related. The comment data can include, for each comment, a reference 220 to a location within the electronic document, a user identifier 222 of the end user that added the comment, and content 224 of the comment, which is typically text but is not limited to text. The reference 220 to a location in a document can be, for example, an offset within the electronic document, such as an offset within the content associated with a structural element of the electronic document. The user identifier can be any indication of a user, such as an email address, user name, etc., such as the user name for the user to access the shared storage system that stores the electronic document. State information 226 also can be associated with a comment, such as data indicating whether the comment has been resolved. A comment also can have an associated date and time stamp 228 indicating when the comment was added to the electronic document. The comment can have a comment identifier 230 that distinguishes the comment from other comments associated with the electronic document.

Comments can be threaded, such that a comment refers to another comment, perhaps in the form of a reply. There are a variety of ways to implement comment threading, such as using the reference 220 of a first comment to refer to a comment identifier 230 of another comment, or using a linked list to represent a comment and any reply comments associated with it.

Data defining comments, in one implementation, can be stored within the electronic document data file, for example as one stream of data among a plurality of streams of data within the electronic document data file. In this implementation, the data defining the comments can be stored as one stream, separate from another stream storing the structure and content of the electronic document, within the electronic document data file.

Activity data 208 defining a collection of actions associated with an electronic document can include a document identifier 209 indicating the electronic document to which the collection of actions is related. The activity data can include, for action 240, an action identifier 241, data indicating a type of action 242, a user identifier 244 of the end user associated with the action, and a date and time stamp 246 indicating when the action occurred. As in the comment data, the user identifier can be any indication of a user, such as an email address, user name, etc., such as the user name for the user to access the shared storage system that stores the electronic document. The type of action 242 can indicate whether the action is a type of action with respect to the electronic document, or a type of action with respect to a comment, a document message or other action. Other data 248, such as text or other information, can be stored as part of the data describing the action 240.

The activity data can represent a variety of different kinds of actions performed by users and associated with the electronic document. Such actions can include actions with respect to an electronic document, for example, opening, saving or closing an electronic document, or sharing an electronic document, and so on. Actions also can be actions with respect to a comment, such as adding, editing, or deleting a comment, reply to a comment, or marking a comment as resolved or unresolved. Actions also can include document messages, which are messages between or among users associated with the electronic document stored as an action in the activity data.

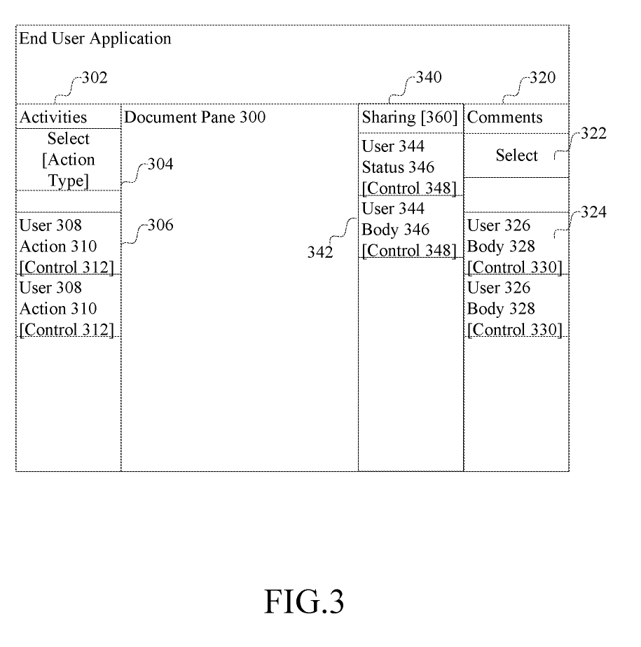

In FIG. 3, an example graphical user interface for an end user application is shown. In this example graphical user interface, a document pane 300 is a primary display area in which the electronic document is presented on a display. The end user computer receives user inputs through one or more input devices, and can associate such inputs with operations with respect to the electronic document in document pane 300, or with respect to other graphical elements in the graphical user interface. The end user computer processes some user inputs to effect modifications to the structure and/or content of the electronic document currently being accessed in the document pane 300.

The graphical user interface for the end user application can include an activity pane 302 in which the end user application displays one or more actions associated with the electronic document. It should be understood that a variety of techniques can be used to display and input activity data, and the invention is not limited thereby. In response to user input, various settings can be provided that control the display of the activity data. For example, the activity pane can include one or more selection elements 304. In response to user inputs with respect to a selection element, the end user application can display actions from the activity data for the electronic document currently presented in the document pane 300. For example, the selection element 304 can provide a mechanism through which the end user application receives inputs specifying how any displayed actions are searched, filtered, sorted, and/or viewed in the activity pane 302. In response to selection of this control, one or more user interface elements can be used to provide for user input of a variety of settings.

In the activity pane, an action is displayed by generating a graphical representation 306 of the action. This graphical representation can include an indication 308 of the user that performed the action, which can include a name, user name and/or picture of the user, and a body 310 of the action, which is typically text. The graphical representation of an action can include other data describing the action as well as have visual appearance parameters related to the action. This graphical representation 306 of an action can be generated using a variety of data accessible through the data for the action. For example, the user identifier can be used to access profile information of the user from the shared storage system.

Given one or more displayed actions in the activity pane, the end user application is configured to be responsive to user input associated with the activity pane to select one or more actions, and to be responsive to user input with respect to a selected one or more actions. For example, the system can be responsive to user input associated with a selected action in the activity pane to initiate communication with the user associated with the selected action using the communication application.

For example, graphical elements in the graphical representation of the action can include one or more controls 312, such as a button or a contextual menu, that allow an end user to provide input with respect to a displayed action. For example, a contextual menu item or a button can be associated with the displayed indication of the user related to a selected action, to allow a user to initiate communication with that user. In response to a user input with respect to the control, the end user application can invoke the communication application, providing the user identifier and context to the communication application as inputs.

In the example shown in FIG. 3, the graphical user interface for the end user application also can include a comments pane 320 in which the end user application displays one or more comments associated with the electronic document. It should be understood that a variety of techniques can be used to display and input comments, and the invention is not limited thereby. In response to user input, various settings can be provided that control the display of the comment data. For example, the comments pane can include a selection element 322. In response to user inputs with respect to the selection element, the end user application displays comments for the electronic document currently presented in the document pane 300. For example, the selection element 322 can provide a mechanism through which the end user application receives inputs specifying how comments are viewed in the comments pane 320.

Generally speaking, the data displayed in the comments pane is a representation of the collection of comments, typically starting with a first comment associated with any currently displayed portion of the document. This display can be interactively updated based on a current cursor position in the document or a currently displayed portion of the document. The comment view also can have a scroll bar. In response to manipulation of the scroll bar, different portions of a list of comments can be viewed. The invention is not limited to any particular kind of display of the comment data. The display of the comment data also can be integrated with the display of the structure and content of the electronic document in the document pane.

In the comments pane of FIG. 3, a comment is displayed by generating a graphical representation 324 of the comment including an indication 326 of the user that created the comment, which can include a name, user name and/or picture of the user, and the body 328 of the comment, which is typically text but can include other data, as well as other visual appearance parameters related to the comment. This graphical representation 324 of a comment can be generated using a variety of data accessible through the data for the comment. For example, the user identifier can be used to access profile information of the user from the shared storage system.

Given one or more displayed comments, the end user application is configured to be responsive to user input associated with the comments to select one or more comments, and to be responsive to user input with respect to a selected one or more comments. For example, the system can be responsive to user input associated with a selected comment in the comment pane to initiate communication with the user associated with the selected comment using the communication application.

For example, graphical elements in the graphical representation of the comment can include one or more controls 330, such as a button or contextual menu, that allow an end user to provide input with respect to a displayed comment. For example, a contextual menu item or button can be associated with the displayed indication of the user related to a selected comment, to allow a user to initiate communication with that user. In response to a user input with respect to that control, the end user application can invoke the communication application, providing the user identifier and context to the communication application as inputs.

In the example shown in FIG. 3, the graphical user interface also can include a sharing interface 340. The sharing interface 340 presents information about the sharing status and the current use of the currently accessed electronic document. In particular, such information can include an indication of each user with whom the electronic document is shared, and the current use, if any, of that electronic document by that user. It should be understood that a variety of techniques can be used to display and input comments, and the invention is not limited thereby.

In one implementation, in the sharing interface, an indication of a user is displayed by generating a graphical representation 342 of the user. This graphical representation can include an indication 344 of the user, which can include a name, user name and/or picture of the user, and status information 346, indicating the current use. The graphical representation 342 can be generated by accessing the shared storage system using an identifier of the electronic document being edited, such as a file name or document identifier, to retrieve information about its sharing status. Information about co-authoring state can be obtained by querying the collaboration system using the identifier of the electronic document being edited. Thus, the graphical representation 342 of a user can include a user identifier, such as a user name and/or picture, and status information, such as “owner”, “co-author” or “editing”, or “shared”.

Given one or more displayed users in the sharing interface, the end user application is configured to be responsive to user input associated with the sharing interface to select a user, and to be responsive to user input with respect to the selected user. For example, the system can be responsive to user input associated with a selected user in the sharing interface to initiate communication with the selected user using the communication application. A control 360 also can be provided to allow a user to initiate sending a message to all of the users with whom the electronic document is shared.

For example, the graphical representation of a user in the sharing interface can include one or more controls 348, such as a button or contextual menu, that allow an end user to provide input with respect to a displayed user. For example, a contextual menu item or button can be associated with the displayed user, to allow a user to initiate communication with the displayed user. In response to a user input with respect to that control, the end user application can invoke the communication application, providing the user identifier and context to the communication application as inputs.

In the example shown in FIG. 3, the end user application presents the activity pane, the comments pane, and the sharing interface in the context of the currently accessed electronic document. In particular, in this example, the document pane 300, activity pane 302, comments pane 320 and sharing interface 340 are displayed in the graphical user interface simultaneously. In this example in FIG. 3, the interfaces are illustrated as panes of the graphical user interface which are non-overlapping and non-modal with the other panes of the interface. Each of the activity pane, comments pane and sharing interface also can be implemented using other graphical user interface techniques. A modal dialog box, a call-out interface, or small pop-up window also are examples of a kind of interface that can be shown in the context of the currently accessed electronic document. Whether the activity pane, the comments pane and the sharing interface are displayed also can be individually controlled, thus any combination of them or none of them may be displayed at any given time.

Thus, in the end user application graphical user interface, an indication of a user in the context of an electronic document is associated with a gesture or other user input, in response to which the end user application invokes the communication application, providing the user identifier and context to the communication application as inputs. This indication of a user can be in the form of a displayed representation of the user in an activity, comment, sharing status, as shown in FIG. 3, or other indication of the user. The input can be associated with a graphical representation of a control in the graphical user interface or can be some other user input that is associated with the indication of a user, such as keyboard input, voice input or the like.

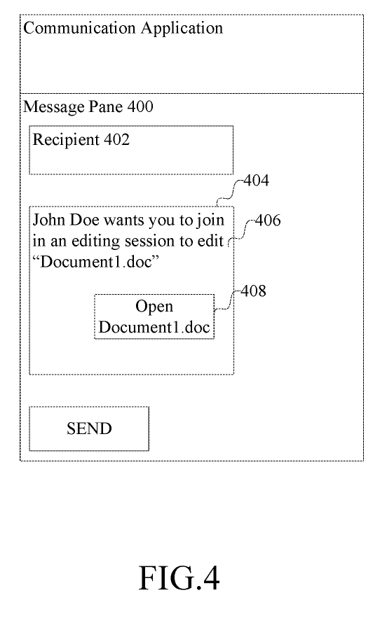

Referring now to FIG. 4, an example graphical user interface for a communication application that is responsive to an end user application to initiate a message to a user, will now be described. As noted above, the communication application is invoked by the end user application and is provided, as inputs, an indication of one or more users and context, such as a document identifier, of an editing session in the end user application. In the example shown in FIG. 4, the communication application presents to a user a message that has been prepopulated. In particular, a graphical user interface of the communication application presents a message pane 400, which includes an indication 402 of a recipient of a message, and a body 404 of the message. The indication of the recipient of the message is based on the user identifier received from the end user application, and can be presented in a variety of ways, such as a name, a picture, a username, and/or contact information. The body of the message can include, for example, text 406, such as text based on a template. An example template is “[SenderUserID.name] wants you to join an editing session to edit ‘[DocumentID.filename]’”, where the values of [SenderUserID.name] and [DocumentID.name] are determined based on the input received from the end user application. A control 408, such as a button or contextual menu, can be included in the message. In response to a user input with respect to the control, the recipient's communication application invokes an end user application associated with a document to open that document. After prepopulating fields of a message with message data and presenting the message in the message pane, the graphical user interface can otherwise operate as a conventional communication application to allow the message to be further edited then sent. Alternatively, the communication application can be configured to immediately send the message without further intervention by the first user.

A communication application for the second user receives the message and presents the message to the second user. The communication application can present the message in substantially the same format as shown in FIG. 4. In the second user's communication application, however, the received message is not available for editing, but the second user can edit and send response messages as usual. The control 408 in the received message can be manipulated to cause the communication application to invoke the second user's end user application to open the document.

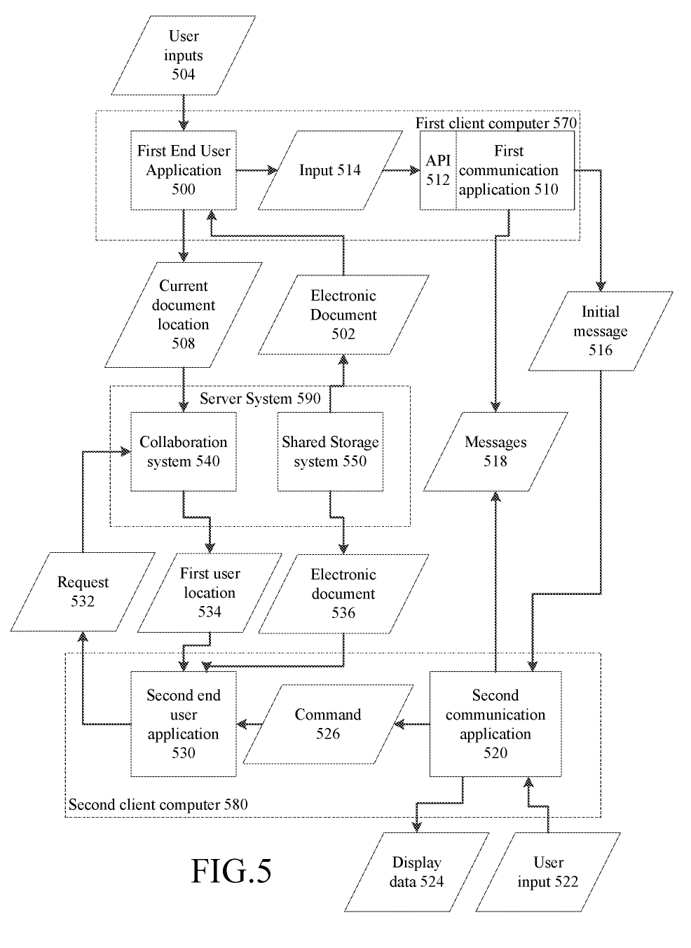

Turning now to FIG. 5, a data flow diagram of an example implementation of a computer system, in which such coordination among end user applications and communication applications can occur, will now be described.

A first end user application 500, running on a first client computer 570, is used by a first user to access and modify an electronic document 502 stored in and accessed from a shared storage system 550 on a server system 590. The server system 590 can include one or more server computers. The electronic document 502 has a document identifier within the shared storage system 550 and used by a collaboration system 540 associated with a shared storage system 550 to distinguish this electronic document from others. The first end user application has an input to receive user inputs 504. An output provides a current editing location 508 for the first user in the electronic document 502 to the collaboration system 540.

The first client computer also includes a first communication application 510 used by the first user. The first communication application 510 is programmed to include an application programming interface 512 that can receive an input 514, from the end user application 500, which includes a user identifier and context, including a document identifier of the currently edited document. The input 514 may be in the form of an operating system command that invokes the communication application with one or more parameters.

In response to the input 514, the first communication application 510 for the first user generates an initial message 516 that is addressed to the user identifier (of a second user) specified by the input 514 and includes in its body the document identifier specified by the input 514. The sender of the message is identified using a user identifier for the first user. The message 516 is sent to a second communication application 520 for a second user. This message may be directed through a server computer (not shown) that maintains a communication service that supports the first and second communication applications 510 and 520. After transmission of the first message 516 from the first communication application to the second communication application 520, additional messages 518 may be transmitted between the users.

The second communication application 520 generates display data 524 based on the initial message to convey the invitation to join in editing of the electronic document to a second user. In response to a user input 522 from the second user, the second communication application 520 can send a command 526 to invoke a second end user application 530 on the second client computer 580. The command 526 may be in the form of an operating system command that invokes the second end user application with one or more parameters, such as the document identifier. In response to the command 526, the end user application 530 for the second user is invoked and retrieves the electronic document, identified by the document identifier in the command, from the shared storage system 550 as indicated at 536. It is possible that, for some reason, the access control rights managed by the shared storage system 550 indicate that the second user is not authorized to access the electronic document using the second end user application, in which case an exception arises and the second user is informed by the second end user application that the requested document is unavailable.

The second end user application 530 can coordinate with the collaboration system 540 to request 532 a location 534 within the electronic document at which the first user is currently editing the electronic document using the first end user application. Alternatively, such location information may have been included in the context information by the first end user application in the input 514 to the first communication application, which in turn passes the location in the message 516 to the second communication application, which in turn passes the location in the command 526 to the second end user application.

Thus, the first user, using the first end user application 500, and the second user, using the second end user application 530 have the same electronic document open to the same location in a collaborative editing mode. The users also can continue to communicate through their respective communication applications 510 and 520.

In the collaborative editing mode, the computer system can provide a number of different mechanisms for ensuring consistency of the electronic document. In one example implementation (not shown in FIG. 5), electronic documents are stored in data files in local storage, which are synchronized with copies of the data files on a server computer in the shared storage system. For example, a client computer can include a client application that periodically transmits an updated file of the electronic document from the local storage to the server computer. Such a transmission can occur in response to save operations, for example, or in response to major changes in context. The server computer then transmits a copy of the electronic document received from one client computer to the other client computers that are using that electronic document. The client applications on the other client computers receive the updated file of the electronic document from the server computer, and then updates their copies in their local storage.

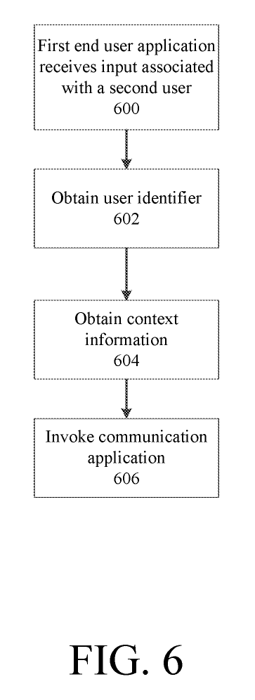

Flowcharts of example implementations of each of the end user applications and communication applications in FIG. 5 will now be described in connection with FIGS. 6-9.

FIG. 6 is a flowchart describing an example implementation of an operation of the first end user application. The first end user application receives 600 an input associated with a second user, such as through the graphical user interface displaying a comment, an action or sharing status of the electronic document. The input indicates a command to invoke the first communication application. The first end user application obtains 602 the user identifier; the application also obtains 604 context information such as the document identifier of the electronic document currently being edited. The first end user application then invokes 606 the first communication application, providing the user identifier and the context information.

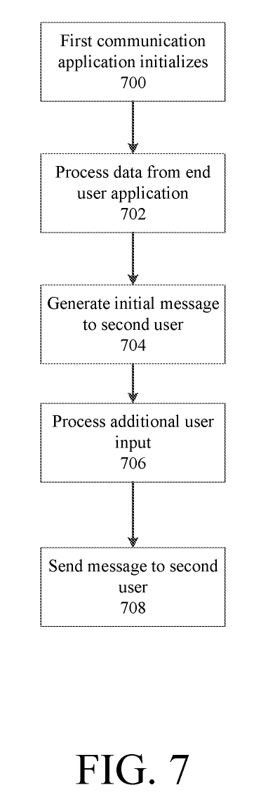

FIG. 7 is a flowchart describing an example implementation of an operation of the first communication application. The first communication application initializes 700 after being invoked, if the communication application was not yet being executed, in response to the first end user application. The first communication application processes 702 data received from the first end user application to extract the user identifier and context information, such as the document identifier. The first communication application generates 704 an initial message using the user identifier and the context information. The initial message includes content indicative of an invitation to the second user to open the electronic document currently being edited by the first user. Any further input from the first user can be processed 706, such as to edit the initial message prior to sending. The first communication application then sends 708 the message to the second user corresponding to the user identifier.

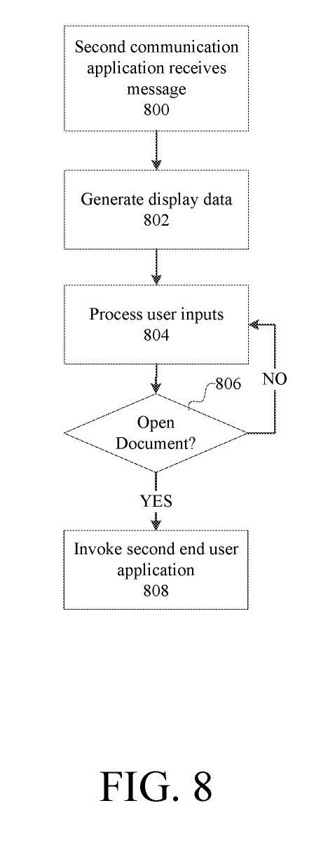

FIG. 8 is a flowchart describing an example implementation of an operation of the second communication application. The second communication application receives 800 the message and generates 802 display data or other output data for displaying or otherwise presenting the message to the second user, including an indication of the invitation to open the electronic document currently being edited by the first user. The communication application can process 804 a variety of user inputs, such as to send and receive further messages. If the second user provides a user input associated with the invitation in the initial message to open the electronic document, as determined at 806, then the second communication application invokes 808 the second end user application with a command that includes the document identifier of the electronic document.

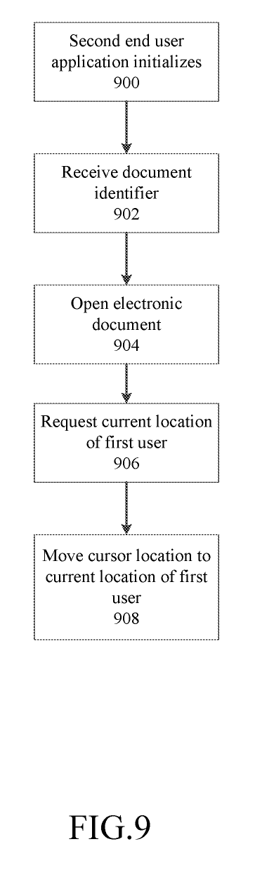

FIG. 9 is a flowchart describing an example implementation of an operation of the second end user application. The second end user application initializes 900, if not already running, and receives 902 the document identifier for an electronic document. The second end user application then opens 904 the electronic document by requesting the document from the shared storage system. The second end user application can request 906 the current location of the first user in the electronic document from the collaboration system, or may have received this information from the second communication application. The second end user application can then move 908 the cursor location to match the current location of the first user.

The foregoing example implementations are based on an end user application for a first user invoking a communication application to transmit a message to a second user to invite the second user to join editing of an electronic document, using context information provided by the end user application.

In another embodiment, the communication application can be invoked by another application that provides a user identifier and a document identifier obtained in another way. For example, a first user can use a contact application that provides contact information for users. The contact application can be configured to access the shared storage system using identifiers for the first user and another user, identified by the stored contact information, to request document identifiers for electronic documents shared by both users. The contact application, in response to an input from the first user, can invoke the communication application to send a message to the other user, with one or more document identifiers, to invite the other user to a collaborative editing session. The communication application can itself be such a contact application.

In another embodiment, the second end user application can be invoked by the second user by providing a document identifier obtained by another application in another way, other than through a message from the first communication application. For example, a contact application, or the second communication application, used by the second user, can identify the first user. The contact application can be configured to access the shared storage system using identifiers for the first user, identified by the stored contact information, and the second user, to request document identifiers for electronic documents shared by both users, and to access the collaborative editing system to determine if any of these documents are currently in use by the first user. The contact application, in response to an input from the second user selecting a document identifier of a document known to be shared with the first user, and currently being edited by the first user, invokes the second end user application to enter into a collaborative editing session with the first user.

By providing information about currently edited documents of a first user to a second user in manner that allows the second user to invoke an appropriate end user application to join in a collaborative editing session with the first user, such collaborative editing sessions are more easily created. Such information can be provided by the first user sending a message to the second user with such document information. Alternatively the second user can use an application that identifies documents shared between the first and second users and currently being edited by the first user, to join in editing of such documents.

Having now described an example implementation, FIG. 10 illustrates an example of a computer with which such techniques can be implemented. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

With reference to FIG. 10, a computer 1000 includes at least one processing unit 1002 and memory 1004. The computer can have multiple processing units 1002 and multiple devices implementing the memory 1004. A processing unit 1002 can include one or more processing cores (not shown) that operate independently of each other. Additional co-processing units also can be present in the computer. The memory 1004 may include volatile devices (such as dynamic random access memory (DRAM) or other random access memory device), and non-volatile devices (such as a read-only memory, flash memory, and the like) or some combination of the two. Other storage, such as dedicated memory or registers, also can be present in the one or more processors. The computer 1000 can include additional storage, such as storage devices (whether removable or non-removable) including, but not limited to, magnetically-recorded or optically-recorded disks or tape. Such additional storage is illustrated in FIG. 10 by removable storage device 1008 and non-removable storage device 1010. The various components in FIG. 10 are generally interconnected by an interconnection mechanism, such as one or more buses 1030.

A computer storage medium is any medium in which data can be stored in and retrieved from addressable physical storage locations by the computer. A computer storage medium thus can be a volatile or nonvolatile memory, or a removable or non-removable storage device. Memory 1004, removable storage 1008 and non-removable storage 1010 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

Computer 1000 may also include communications connection(s) 1012 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media, such as metal or other electrically conductive wire that propagates electrical signals or optical fibers that propagate optical signals, and wireless media, such as any non-wired communication media that allows propagation of signals, such as acoustic, electromagnetic, electrical, optical, infrared, radio frequency and other signals. Communications connections 1012 are devices, such as a wired network interface, wireless network interface, radio frequency transceiver, e.g., WiFi 1070, cellular 1074, long term evolution (LTE) or Bluetooth 1072, etc., transceivers, navigation transceivers, e.g., global positioning system (GPS) or Global Navigation Satellite System (GLONASS), etc., or other devices 1076 that interface with communication media to transmit data over and receive data from the communication media.

The computer 1000 may have various input device(s) 1014 such as a pointer device, keyboard, touch-based input device, pen, camera, microphone, sensors, such as accelerometers, thermometers, light sensors and the like, and so on. The computer 1000 may have various output device(s) 1016 such as a display, speakers, and so on. Such devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various storage 1010, communication connections 1012, output devices 1016 and input devices 1014 can be integrated within a housing with the rest of the computer, or can be connected through various input/output interface devices on the computer, in which case the reference numbers 1010, 1012, 1014 and 1016 can indicate either the interface for connection to a device or the device itself as the case may be.

A computer generally includes an operating system, which is a computer program that manages access to the various resources of the computer by applications. There may be multiple applications. The various resources include the memory, storage, input devices and output devices, such as display devices and input devices as shown in FIG. 10.

The various modules and data structures of FIGS. 1-2 and 5, the graphical user interfaces in FIGS. 3-4 and the flowcharts of FIGS. 6-9, as well as any operating system, file system and applications on a computer in FIG. 10, can be implemented using one or more processing units of one or more computers with one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct or configure the computer to perform operations on data, or configure the computer to implement various components, modules or data structures.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Accordingly, in one aspect, a computer, configured as a local client computer, includes a computer comprises a network interface configured to connect the computer to a computer network. The computer network is connected to a shared storage system. The shared storage system comprises a file system configured to store a plurality of electronic documents and to make the plurality of electronic documents available to a plurality of users. The computer comprises a processing system that includes one or more processing units and storage, the storage comprising computer program code that, when executed by the processing system, configures the processing system. The processing system, as configured by the computer program code, comprises a communication application and an end user application. The communication application is configured to communicate messages from a first user to other users of other computers. The end user application is configured to process user input to modify an electronic document. The end user application includes a graphical user interface configured to present indicia of other users associated with the electronic document. The end user application is further configured to, in response to user input associated with indicia of a second user in the graphical user interface, invoke the communication application including providing an indication of the second user and context information from the end user application to the communication application. The communication application is configured to, in response to the invocation by the end user application, generate and transmit a message to the second user including context information from the end user application.

In another aspect, a computer-implemented process comprises an end user application processing user input from a first user to modify an electronic document. The end user application presents indicia of other users associated with the electronic document. The end user application, in response to user input associated with indicia of a second user, invokes a communication application including providing an indication of the second user and context information from the end user application to the communication application. The communication application, in response to the invocation by the end user application, generates and transmits a message to the second user including context information from the end user application.

In another aspect, an end user application is configured to, in response to user input associated with indicia of a second user in the graphical user interface, invoke the communication application including providing an indication of the second user and context information from the end user application to the communication application.

In another aspect, an end user application includes means responsive to user input associated with indicia of a second user in the graphical user interface, invoke the communication application including providing an indication of the second user and context information from the end user application to the communication application.

In another aspect, a communication application is configured to, in response to an invocation by an end user application operated by a first user and providing an indication of a second user and context information from the end user application, generate and transmit a message from the first user to a second user including the context information from the end user application.

In another aspect, a communication application has an application programming interface configured to receive input from an end user application operated by a first user and providing an indication of a second user and context information from the end user application. In response to an invocation by the end user application through the application programming interface, the communication application generates and transmits a message from the first user to a second user including the context information from the end user application.

In another aspect, a communication application includes means, operative in response to an invocation by an end user application operated by a first user and providing an indication of a second user and context information from the end user application, for generating and transmitting a message from the first user to a second user including the context information from the end user application.

In any of the foregoing aspects, the context information includes a document identifier of an electronic document currently edited by the first user in the end user application.

In any of the foregoing aspects, context information can include a location within the electronic document.

In any of the foregoing aspects, the graphical user interface can include a sharing interface indicative of sharing status of the currently edited electronic document. The sharing status can include an indication of each user having shared access to the electronic document.

In any of the foregoing aspects, the end user application can be configured such that, in response to user input, the end user application invokes the communication application to send the message to all users having shared access to the electronic document.

In any of the foregoing aspects, the graphical user interface includes a comment interface presenting information about comments associated with the electronic document including indicia of other users having added the comments to the electronic document.

In any of the foregoing aspects, the graphical user interface can include an activity interface indicative of actions performed by users with respect to the currently edited electronic document. In response to user input with respect to an indication of a user associated with an action presented in the activity interface, the end user application invokes the communication application.

In any of the foregoing aspects, the graphical user interface of the end user application can include a document pane configured to display the electronic document for editing.

In another aspect, an article of manufacture includes at least one computer storage medium, and computer program instructions stored on the at least one computer storage medium. The computer program instructions, when processed by a processing system of a computer, the processing system comprising one or more processing units and storage, configures the computer as set forth in any of the foregoing aspects and/or performs a process as set forth in any of the foregoing aspects.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

It should be understood that the subject matter defined in the appended claims is not necessarily limited to the specific implementations described above. The specific implementations described above are disclosed as examples only.

What is claimed is:

1. A computer, comprising:
a network interface configured to connect the computer to a computer network, the computer network being connected to a shared storage system, the shared storage system comprising a file system configured to store a plurality of electronic documents and to make the plurality of electronic documents available to a plurality of users; and
a processing system comprising one or more processing units and storage, the storage comprising computer program code that, when executed by the processing system, configures the processing system to comprise:
a communication application configured to communicate messages from a first user to other users of other computers;
an end user application configured to process user input from the first user to modify an electronic document, the end user application comprising a graphical user interface configured to present indicia of other users associated with the electronic document, the end user application configured to, in response to user input associated with indicia of a second user in the graphical user interface, invoke the communication application including providing an indication of the second user and context information from the end user application to the communication application; and
the communication application configured to, in response to the invocation by the end user application, generate and transmit a message to the second user including context information from the end user application.

2. The computer of claim 1, wherein the context information includes a document identifier of an electronic document currently edited by the first user in the end user application.

3. The computer of claim 2, wherein the context information further includes a location within the electronic document.

4. The computer of claim 1, wherein graphical user interface includes a sharing interface indicative of sharing status of the currently edited electronic document.

5. The computer of claim 4, wherein the sharing status includes an indication of each user having shared access to the electronic document.

6. The computer of claim 5, wherein the end user application, in response to user input, sends the message to all users having shared access to the electronic document.

7. The computer of claim 1, wherein the graphical user interface includes a comment interface presenting information about comments associated with the electronic document including indicia of other users having added the comments to the electronic document.

8. An article of manufacture comprising:
at least one computer storage medium,
computer program instructions stored on the at least one computer storage medium which, when processed by a processing system of a computer, the processing system comprising one or more processing units and storage, configures the computer to comprise:
a network interface configured to connect the computer to a computer network, the computer network being connected to a shared storage system, the shared storage system comprising a file system configured to store a plurality of electronic documents and to make the plurality of electronic documents available to a plurality of users; and
a communication application configured to communicate messages from a first user to other users of other computers;
an end user application configured to process user input from the first user to modify an electronic document, the end user application comprising a graphical user interface configured to present indicia of other users associated with the electronic document, the end user application configured to, in response to user input associated with indicia of a second user in the graphical user interface, invoke the communication application including providing an indication of the second user and context information from the end user application to the communication application; and
the communication application configured to, in response to the invocation by the end user application, generate and transmit a message to the second user including context information from the end user application.

9. The article of manufacture of claim 8, wherein the context information includes a document identifier of an electronic document currently edited by the first user in the end user application.

10. The article of manufacture of claim 8, wherein the context information further includes a location within the electronic document.

11. The article of manufacture of claim 8, wherein graphical user interface includes a sharing interface indicative of sharing status of the currently edited electronic document.

12. The article of manufacture of claim 11, wherein the sharing status includes an indication of each user having shared access to the electronic document.

13. The article of manufacture of claim 12, wherein the end user application, in response to user input, sends the message to all users having shared access to the electronic document.

14. The article of manufacture of claim 8, wherein the graphical user interface includes a comment interface presenting information about comments associated with the electronic document including indicia of other users having added the comments to the electronic document.

15. A computer-implemented process comprising:
an end user application processing user input from a first user to modify an electronic document;
the end user application presenting indicia of other users associated with the electronic document;
the end user application, in response to user input associated with indicia of a second user, invoking a communication application including providing an indication of the second user and context information from the end user application to the communication application; and
the communication application, in response to the invocation by the end user application, generating and transmitting a message to the second user including context information from the end user application.

16. The computer-implemented process of claim 15, wherein the context information includes a document identifier of an electronic document currently edited by the first user in the end user application.

17. The computer-implemented process of claim 15, wherein the context information further includes a location within the electronic document.

18. The computer-implemented process of claim 15, further comprising presenting a sharing interface indicative of sharing status of the currently edited electronic document.

19. The computer-implemented process of claim 18, wherein the sharing status includes an indication of each user having shared access to the electronic document.

20. The computer-implemented process of claim 19, further comprising;
the end user application, in response to user input, sending the message to all users having shared access to the electronic document.
